(19) United States
(12) Patent Application Publication
(10) Pub. No.: US 2010/0274670 A1
(43) Pub. Date: Oct. 28, 2010

(54) Advertisement Platform

(75) Inventors: James Sonnick, Rochester, NY (US); Michael G. Thorpe, Fairport, NY (US)

Correspondence Address: HULSEY IP INTELLECTUAL PROPERTY LAWYERS, P.C., 919 Congress Avenue, Suite 919, AUSTIN, TX, 78701, US

(73) Assignee: SOLEO COMMUNICATIONS, INC., Fairport, NY (US)

(21) Appl. No.: 12/767,674

(22) Filed: Apr. 26, 2010

Related U.S. Application Data
(60) Provisional application No. 61/172,408, filed on Apr. 24, 2009.

(51) Int. Cl. G06Q 30/00; H04W 4/14

(52) U.S. Cl. 705/14.64; 455/466

(57) ABSTRACT

A mobile advertisement is stored in a database associated with an advertisement platform. A unique ad ID identifying a corresponding advertisement placement is associated with the mobile advertisement. The unique ad ID is communicated to an advertisement sender along with the corresponding advertisement placement. A message provided by said advertisement sender is parsed to identify the unique ad ID and mobile device contact information for an advertisement recipient in order to forward the associated mobile advertisement to the advertisement recipient. Advertisement placement information based on the unique ad ID received from the advertisement sender is recorded. The mobile advertisement is messaged to the advertisement recipient. The mobile advertisement comprises contact information providing a network path for the advertisement recipient to contact the merchant through the advertisement platform. The instances that the advertisement recipient is routed through the advertisement platform to the merchant are recorded.

### CROSS-REFERENCE TO RELATED APPLICATIONS

This application claims the benefit of provisional patent application 61/172,408 filed on Apr. 24, 2009, which is hereby incorporated by reference in its entirety.

### FIELD

This disclosure relates in general to the field of advertising and more particularly to system and methods for transforming advertisement placements and distributing mobile advertisements to targeted consumers.

### BACKGROUND

One of the oldest forms of advertisement, word of mouth or peer advertising, is also known as one of the most trusted and valuable forms of advertisements. Word of mouth advertising generally refers to a positive referral of an advertiser's product and services delivered to an interested buyer from a trusted source. Advertisers recognize this simple type of advertising as one of the most powerful means of promoting a product available. In a sense, the distributed advertisement is validated in the eyes of the receiver.

Additionally, as the popularity and availability of online advertising has grown, the ease of not only referring a product but also distributing that product's advertisement has also increased. An online advertisement viewed on the internet may be relatively easily forwarded through an email or other online method. Mobile devices supporting online browsing and SMS/MMS messaging also allow users to send/forward content to one another. Thus, a word of mouth referral may contain a merchant's actual advertisement (often as a forwarded website or other online media)—and allow the advertisement recipient to contact the merchant directly through a forwarded website or other contact information.

However, traditional forms of advertising (including various types of print media and audio/visual media advertisement placements) have limited word of mouth distribution capabilities. This is partly because traditional forms of advertisement media are difficult to convert or transform to online or mobile content for real-time distribution. Potential customers viewing a billboard, magazine advertisement, commercial, or hearing a radio advertisement, have difficulty quickly and easily reproducing that advertisement for referral to friends or family who may be interested in the advertisement's product or service. Additionally, sales of traditional advertisements, such as Yellow Pages and print advertising, have fallen as more and more people access directory information on line. Therefore, advertisers continue to shift spending to paid search and online directories from traditional advertising sources.

Merchants also have difficulty measuring and quantifying the impact of traditional types of advertisements, known as advertisement impressions—making it challenging when allocating company funds for different types of advertisements. A buyer may have been prompted to buy a product because of a merchant's advertisement on television, in a newspaper, or heard the advertisement on a radio—yet without interviewing the buyer, the merchant is unable to discern which particular advertisement was effective. On the other hand, the impact of online advertisements may be partly quantified by tracking an online advertisement's traffic or website hits.

As mobile devices grow in popularity and continuously support new types of media content, advertisers (especially IPTV providers) are continuously looking for ways to converge their expanding role in delivering advertising content, such as video ad content, to consumers through their basic wireless and wire line networks. Many wireless service providers believe that their ability to leverage their wireless operations provides a decided advantage over the competition (such as cable companies) that does not have wireless networks to leverage.

Currently, on-line and mobile contextual ad placement is often essentially a guessing game where ads are placed based upon keywords appearing in a web page. However the simple matching of keywords may result in the placement of ads that are inappropriate, potentially damaging the reputation of both the publisher and the advertiser. Ads that are poorly placed are a wasted impression for the publisher because no one will follow the ad (i.e. click the website link), and a wasted ad buy for the advertiser. This situation may be somewhat mitigated when a merchant buys contextual ads through an ad provider—as these providers may prevent the ads from showing up on certain sites, block out certain keywords, and even target consumers by location. However, it would seem that there is little way for anyone to devise a system to eliminate situations where ads placed are not relevant to the content the viewer is interested in as well as a word of mouth/referral advertisement accomplishes this goal.

### SUMMARY

Therefore a need has arisen for a word of mouth advertising method and system which provides targeted advertisement distribution capabilities across a mobile network. In accordance with the disclosed subject matter, an advertisement placement transformation and referral distribution method and system is provided which substantially eliminates or reduces disadvantages associated with previously developed advertisement methods.

According to one aspect of the disclosed subject matter, a method for the transformation of an advertisement placement into a mobile advertisement and the targeted distribution of that mobile advertisement is provided which allows a user to send an advertisement to another as a mobile advertisement on a mobile device. Further, the advertising methods of the disclosed subject matter provide an advertising distribution method which allows a user to send an offline advertisement to another across a mobile network.

In accordance with the disclosed subject matter, a mobile advertisement is stored in a database associated with an advertisement platform. A unique ad ID identifying a corresponding advertisement placement is associated with the mobile advertisement. The unique ad ID is communicated to an advertisement sender along with the corresponding advertisement placement. A message provided by said advertisement sender is parsed to identify the unique ad ID and mobile device contact information for an advertisement recipient in order to forward the associated mobile advertisement to the advertisement recipient. Advertisement placement information based on the unique ad ID received from the advertisement sender is recorded. The mobile advertisement, comprising contact information providing a network path for the advertisement recipient to contact the merchant through the advertisement platform, is messaged to the advertisement recipient. The instances the advertisement recipient is routed through the advertisement platform to the merchant are recorded.

Technical advantages of the disclosed subject matter include transforming traditional offline advertisement media into mobile advertisements in order to leverage the technology capabilities of mobile networks. Further, the disclosed subject matter provides a platform and method that tracks ad ID's and matches the ID to a mobile advertisement and provides the mobile advertisement to the receiving party. The disclosed subject matter provides a platform access point and tracking capabilities that allow the receiving party to access the merchant either via the phone (i.e. pay per call functionality) or the web (redirect page). Additionally, the disclosed subject matter tracks the access from the receiver to the merchant, signifying a successful referral, and can provide full tracking data to the merchant or media buyer who placed the ad.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of any claims filed later.

### BRIEF DESCRIPTION OF THE DRAWINGS

The features, natures, and advantages of the disclosed subject matter may become more apparent from the detailed description set forth below when taken in conjunction with the drawings in which like reference characters identify correspondingly throughout and wherein:

FIG. 1 is a graphic representation of a process flow of the present disclosure from the viewpoint of the users;

FIG. 2 is a graphic representation of a process flow of the present disclosure, including the advertisement platform, from the viewpoint of the users;

FIG. 3 is an embodiment of a process flow depicting the major steps of the disclosed advertisement placement transformation and mobile advertisement distribution method;

FIG. 4 is a graphic representation of a process flow of the present disclosure depicting the transformation of an advertisement placement to a mobile advertisement and its distribution to a recipient;

FIG. 5 is a graphic representation of an embodiment of the advertisement platform architecture showing the process flow during the transformation of an advertisement placement to a mobile advertisement and its distribution to a recipient;

FIG. 6 is a graphic representation of an embodiment of the advertisement platform architecture showing the process flow of a referral recipient following the contact information provided in a mobile ad;

FIG. 7 is a graphic representation of a process flow of the present disclosure depicting the transformation of an advertisement placement to a mobile advertisement and its distribution to a recipient; and

FIG. 8 is a graphic representation of an embodiment of a process flow displaying the devices used in accordance with the disclosed subject matter.

### DETAILED DESCRIPTION OF THE SPECIFIC EMBODIMENTS

The following description is not to be taken in a limiting sense, but is made for the purpose of describing the general principles of the present disclosure. The scope of the present disclosure should be determined with reference to the claims. And although described with reference to the targeted distribution of a mobile advertisement over a mobile network, a person skilled in the art could apply the principles discussed herein to various networks and various forms of mobile advertisements.

Preferred embodiments of the present disclosure are illustrated in the drawings, like numbers being used to refer to like and corresponding parts of the various drawings.

The innovative advertisement transformation and referral distribution methods are based on the use of mobile devices to send messages via a short message service (SMS) and/or multimedia messaging service (MMS). In the present disclosure, “mobile advertisements” may take the form of any message media that is supported by a mobile device, including, but limited to, SMS and MMS messages. Further, the term traditional advertisement media is used to refer to offline advertisement placements—this generally includes advertisements that may not be sent online (over the internet). Additionally, the term advertisement placement includes both offline and online advertising media.

In the context of this document, a “memory,” “recording medium,” and “data store” can be any means that contains, stores, communicates, propagates, or transports the program and/or data for use by or in conjunction with an instruction execution system, apparatus, or device. Memory, recording medium, and data store can be, but are not limited to, an electronic, magnetic, optical, electromagnetic, infrared or semiconductor system or device. Memory, recording medium, and data store also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

The disclosed subject matter may be described in the general context of computer-readable instructions, such as program modules, being executed by a computer. Generally, program modules include routines, programs, objects, components, data structures, etc. that perform particular tasks or implement particular abstract data types. The disclosed subject matter may also be practiced in distributing computing environments wherein tasks are performed by remote processing devices that are linked through a communications network. In a distributed computing environment, program modules may be located in local and/or remote computer storage media including memory storage devices.

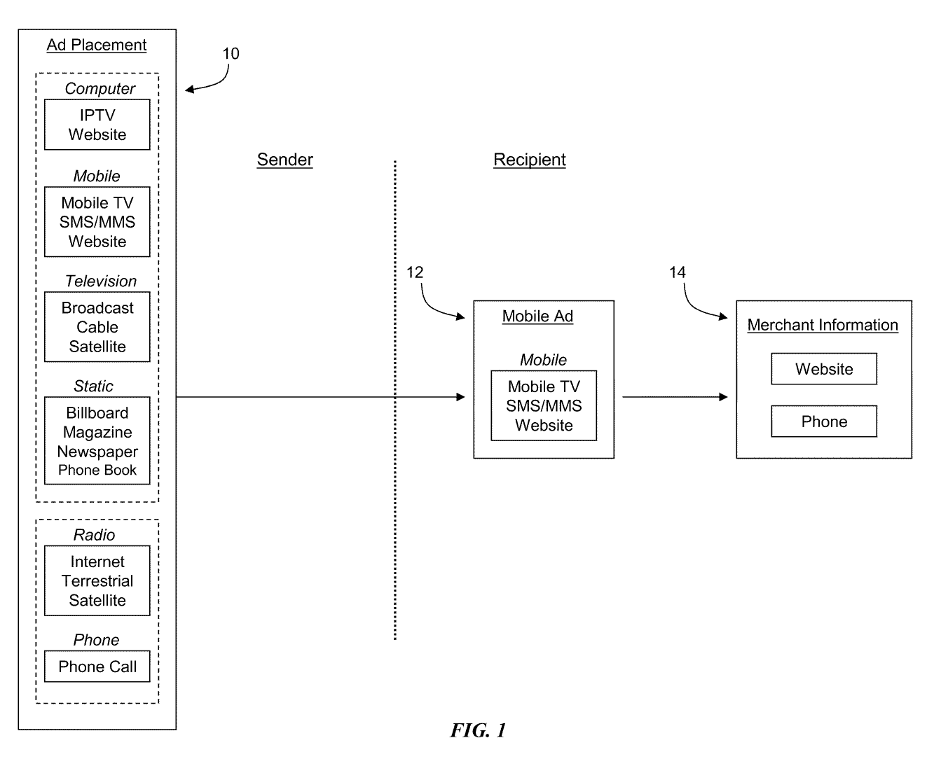

FIG. 1 is a graphic representation of a process flow of the present disclosure from the viewpoint of both the advertisement sender and the advertisement recipient. Shown, a sender sees or hears an advertisement along with a unique ad ID, such as the traditional advertising media examples shown in ad placement 10, that they wish to send/forward to a recipient as a referral who would be interested in the product or services depicted in the ad placement.

For example, forms of traditional visual media advertisements include, but are not limited to: a website or internet protocol television on a computer; mobile TV, SMS/MMS messages, or a website on a mobile device; television advertisements over a broadcast, cable, or satellite network; and print media advertisements such as those found on billboards and in magazines, newspapers, and phonebooks. Forms of traditional audio media advertisements include, but are not limited to: a radio advertisement on an internet, terrestrial, or satellite network; and phone call advertisement such as those made from an automated or staffed call center. The disclosed subject matter also applies online advertising media.

The ad placement is then transformed and the recipient receives a mobile advertisement corresponding to the ad placement seen or heard by the sender, in the form of the examples shown in mobile ad 12, on their mobile device. The form of the mobile ad includes, but is not limited to, a mobile television ad, an SMS or MMS message, or a website or link to a website. The mobile advertisement directs the recipient to additional merchant information 14, in form of a contact website or phone number.

As shown in FIG. 1, the present advertisement transformation and distribution methods allow a sender to refer a traditional media advertisement, i.e. an advertisement that cannot be easily distributed over a network (online or mobile), to a recipient's mobile device. Thus, the ad placement is transformed to a mobile ad and distributed to the recipient to allow for a real time referral. The advertisement platform (not shown in FIG. 1) parses the message sent from the sender to identify the correct mobile advertisement and recipient contact information. From the sender's viewpoint, this would likely entail sending an MMS message comprising a unique ad ID and the recipient's contact information to the advertisement platform. The recipient would then receive a mobile ad to their mobile device as a referral from the sender. Additionally, the MMS message from the sender may include a personal message (such as “I thought you would enjoy this product”) which would also be forwarded to the recipient along with the mobile ad—adding validity to the advertisement referral.

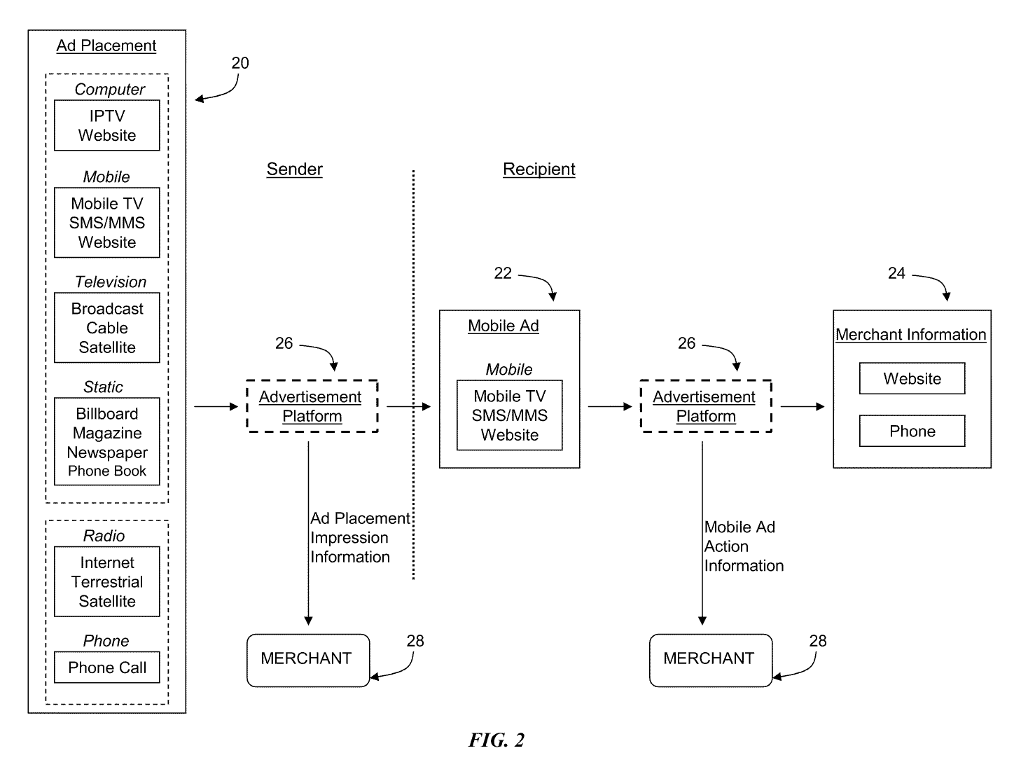

FIG. 2 is a graphic representation of a process flow of the present disclosure, including the advertisement platform, from the viewpoint of both the advertisement sender and the advertisement recipient. As in FIG. 1, a sender sees or hears an advertisement placement along with a unique ad ID, such as those advertisement examples shown in ad placement 20, that they wish to send/forward to a recipient who would be interested in the product or services depicted in the ad placement. The sender then sends a message, in the form of an SMS message, to advertisement platform 26. Advertisement platform 26 then parses that message to identify a corresponding mobile ad, based on the unique ad ID, and the recipient's communication information, in the form of a mobile phone number. Also, based on the unique ad ID, advertisement platform 26 records specific information about the advertisement placement viewed or heard by the sender. That information may then be stored or sent to merchant 28 to allow the merchant to quantify the effectiveness of that particular advertisement—information particularly valuable concerning traditional media advertisements.

Advertisement platform 26 then sends the recipient mobile ad 22 based on the unique ad id received from the sender. Mobile ad 22 also relays contact information for a recipient interested in the product or services depicted in mobile ad 22. This contact information may be in the form of a website link or a phone number. If the sender wishes to contact the merchant, they are routed through advertisement platform 26 to the merchant phone number or website, shown as merchant information 24. The sender's action to contact the merchant, signaling the immediate success of the referral, is captured by advertisement platform 26 as mobile ad action information and may then be stored or sent to merchant 28.

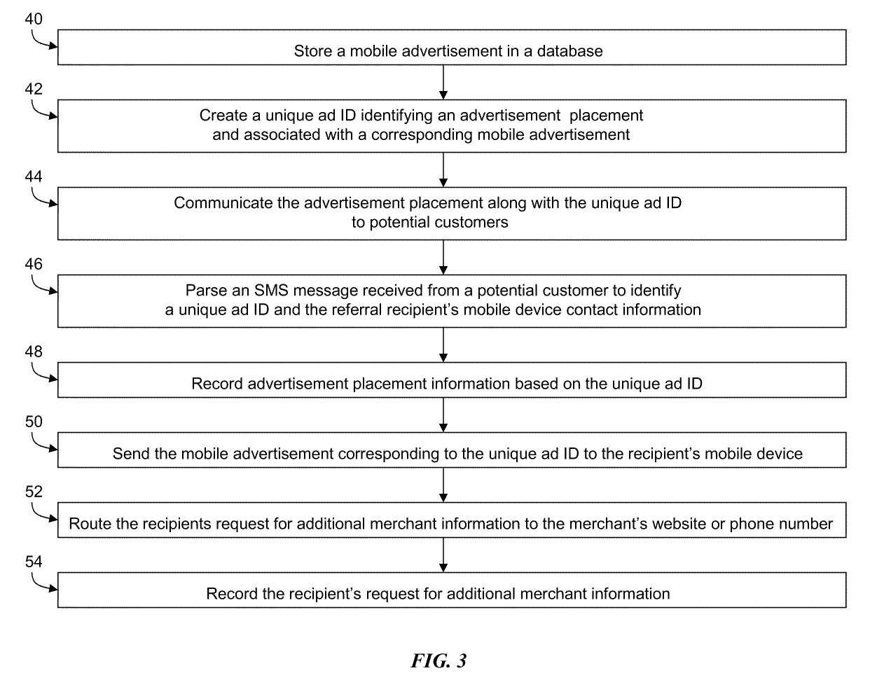

FIG. 3 is an embodiment of a process flow depicting the major steps of the disclosed advertisement placement transformation and mobile advertisement distribution method. In step 40 a mobile advertisement is stored in a database. Often, the stored advertisement will be in the form of a digital image, such as a graphics interchange format (GIF), JPEG, portable network graphics (PNG), or tagged image file format (TIFF). However, because the digital advertisement will be sent over a mobile network, the digital advertisement may be in any form supported by current mobile device technology. The digital advertisement also provides contact information which routes the advertisement recipient along a network path through the advertisement platform in order to capture the recipient's interest in the advertisement.

Next, in step 42, a unique ad is created which identifies an audio or visual advertisement placement and is associated with a corresponding mobile advertisement stored in the database. Preferably, each advertisement placement has a unique ad ID—thus identical print media advertisements in different magazines each have a unique ad ID. This advertisement placement identification system allows the effectiveness of each advertisement placement to be captured each time the advertisement is referred to a recipient according to the present disclosure. The unique ad ID itself may take the form of a numerical or alphabetical code (or combination of both) such as 11112 or 1111A. Thus, in the example given above describing two identical print advertisements in different magazines, the advertisement in Magazine A may have the ad ID 1111A and the advertisement in Magazine B may have the ad ID 1111B. Importantly, various unique ad ID's may correspond to the same mobile advertisement.

In step 44, the unique ad ID is communicated to a potential customer along with the advertisement placement it identifies. In a visual advertisement, the unique ad ID may be presented with advertisement platform contact information (such as a shortcode), with language such as: “To refer this ad to a friend, text 1111A and the friend's mobile number to shortcode *333.” In an audio advertisement, the same language communicating the ad ID and contact information may follow the substantive advertisement. Additionally, the advertisement platform shortcode may act as the unique ad ID itself. In this case, each unique ad ID will be a shortcode that the potential customer may message directly with a referral customer's mobile contact information. In this embodiment, each unique ad ID is a shortcode itself and the advertising platform identifies the unique ad ID based on the shortcode messaged—thus each ad ID would have a corresponding unique shortcode.

In step 46, after a potential customer messages the advertisement platform, the unique ad ID and recipient's number are identified. In step 48, information about the advertisement placement the potential customer wishes to refer is recorded. This information is valuable to the merchant as a measure of the effectiveness of the advertisement placement.

In step 50, based on the unique ad ID, which may be the shortcode itself, the corresponding mobile advertisement is identified and sent to the recipient's mobile device. Contact information is provided to the recipient which in step 52, if followed, routes the recipient through the advertisement platform then to the merchant in order to capture the recipient's request. In step 54, the recipient's request, preferably either by calling a provided phone number or following a website link, is recorded. This information is valuable to the merchant to assess the effectiveness of the advertisement referral.

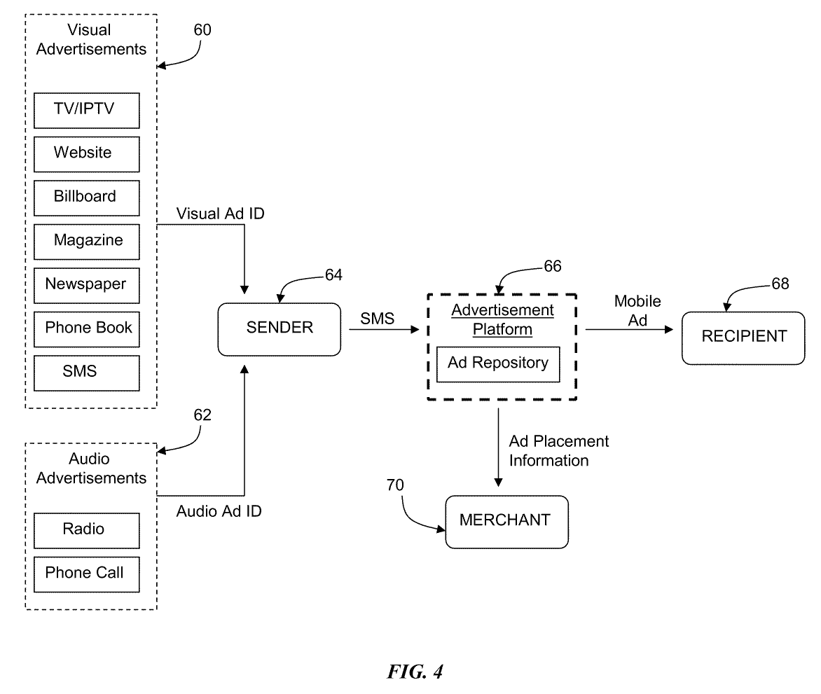

FIG. 4 is a graphic representation of a process flow of the present disclosure depicting the transformation of an advertisement placement to a mobile advertisement and its distribution to a recipient. Visual advertisements 60 include, but are not limited to, advertisement placements on TV, IPTV, a website, on a billboard, in a magazine, in a newspaper, in a phone book, or an SMS advertisement received on a mobile device. Audio advertisements 62, include, but are not limited to, advertisement placements on the radio or over the phone. According to the present disclosure, accompanying these advertisement placements (audio or visual) is a unique ad ID. The ad ID is communicated to potential customers hearing or seeing the advertisement placement. While the ad ID is unique to the specific advertisement placement it accompanies, it may take a number of forms including an alphabetic or numeric code or a shortcode the potential customer may message directly. Additional information may also accompany the ad ID conveying instructions concerning how to refer/forward the advertisement placement to another.

Sender 64 sees or hears the advertisement placement and wishes to refer this advertisement to another as a word of mouth or peer referral. Sender 64 then may SMS message advertisement platform 66 the ad ID and the mobile contact information for recipient 68. The advertisement platform may be available according to a full telephone number or by a shortcode—in which case sender would SMS message the unique ad ID and the mobile contact information for recipient 68. The unique ad ID identifies the corresponding mobile ad to be sent to recipient 68. However, if the ad ID itself is a shortcode, sender 64 need only SMS message the shortcode the mobile contact information for recipient 68 to transform and forward the advertisement placement as a mobile ad because the shortcode identifies the corresponding mobile ad.

Advertisement platform 66 then matches the ad ID to a corresponding mobile ad stored in an ad repository database and sends that mobile ad to recipient 68. The advertisement placement information is recorded, by matching the ad ID to the advertisement placement, and passed along to merchant 70.

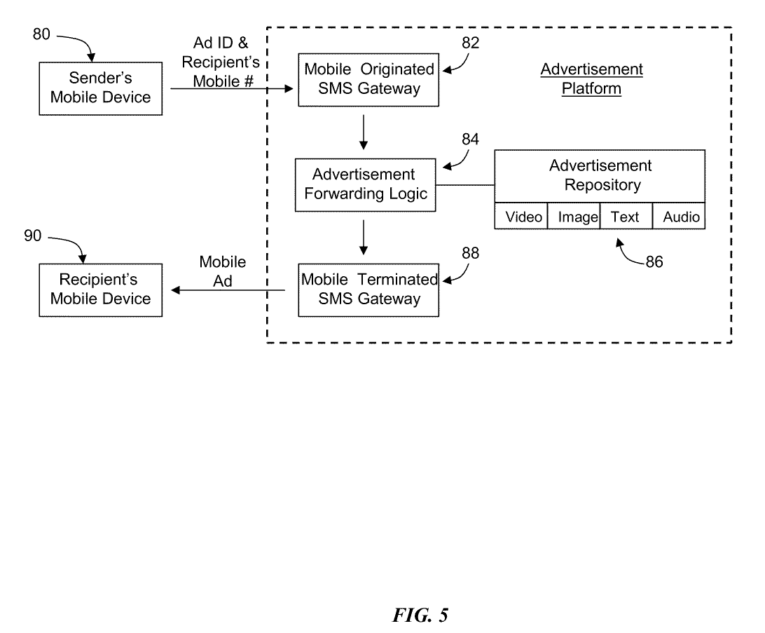

FIG. 5 is a graphic representation of an embodiment of the advertisement platform architecture showing the process flow during the transformation of an advertisement placement to a mobile advertisement and its distribution to a recipient. The unique ad ID and the mobile contact information for the mobile advertisement recipient are sent from sender's mobile device 80 as an SMS to the advertisement platform shortcode. The message is received in the advertisement platform according to an SMS gateway, shown as mobile originated SMS gateway 82. The message is then parsed into the ad ID and the recipient's mobile contact information according to advertisement forwarding logic 84. The mobile ad corresponding to the ad ID is then found in advertisement repository 86 database. The mobile ad itself may take the form any media capable of being transmitted across a mobile network—this includes an image, a video, a text message, or an audio message. Advertisement forwarding logic then forwards the recipient's mobile device number and the mobile ad to be sent to mobile terminated SMS gateway 88. Mobile terminated SMS gateway 88, an SMS gateway, then forwards the mobile ad to recipient's mobile device 90 (according to the number provided by the sender).

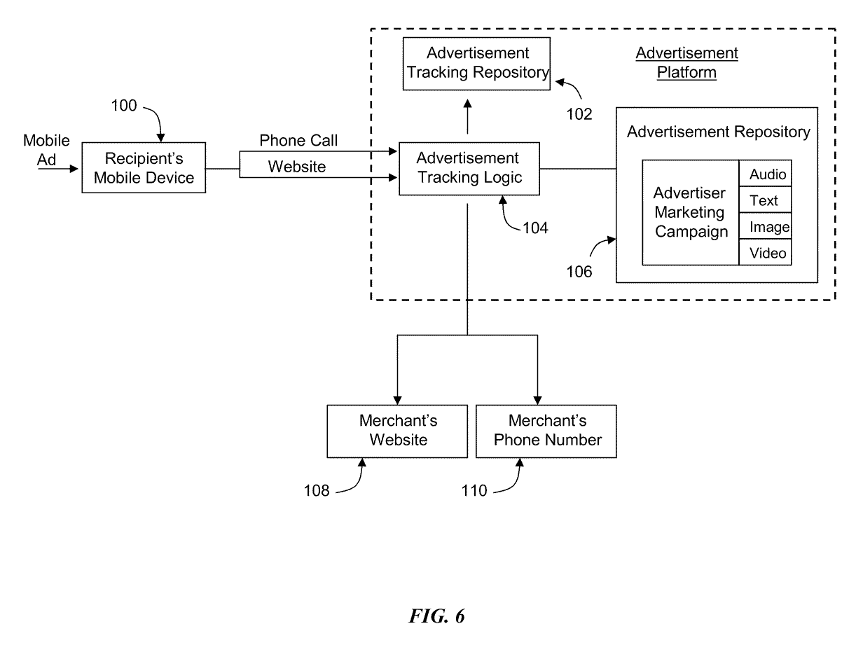

FIG. 6 is a graphic representation of an embodiment of the advertisement platform architecture showing the process flow of a referral recipient following the contact information provided in a mobile ad. A mobile ad (such as an SMS/MMS with the advertisement specified by a sender) is sent to recipient's mobile device 100. This mobile ad contains advertisement platform contact information, preferably in the form of a website or phone number, which allows the recipient to gain more information about or purchase the product/service referred to in the mobile ad. The recipient may then call the phone number or follow the website link provided in the mobile ad and is routed to the merchant's website or phone number through the advertisement platform. Advertisement tracking logic 104 provides an access point for the recipient to access the merchant either via the phone (i.e. pay per call functionality) to access merchant's phone number 110 or via the internet (i.e. as a redirected webpage) to access merchant's website 108.

Advertisement tracking logic 104 uses the ad ID to determine the recipient's destination, merchant's website or merchant's phone number, based on an advertising marketing campaign associated with the ad ID and forwards the recipient directly to that destination. Various methods for capturing the ad ID include: providing the contact website in the mobile ad sent to the recipient as an advertisement platform website with a URL address containing the ad ID or providing a unique contact phone number for each merchant associated with a mobile ad. Advertisement tracking repository 102 captures each instance a recipient is forwarded to a merchant.

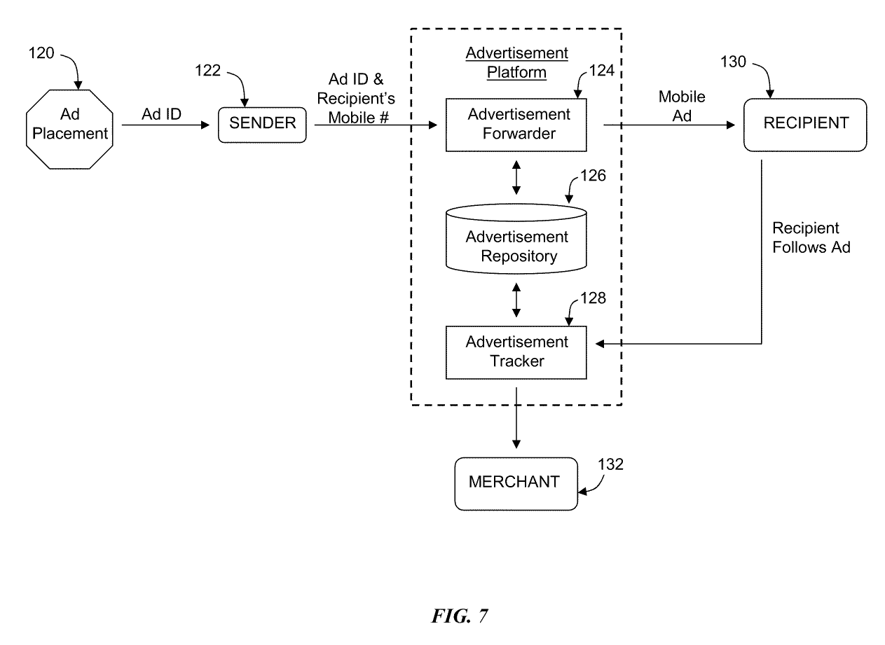

FIG. 7 is a graphic representation of a process flow of the present disclosure depicting the transformation of an advertisement placement to a mobile advertisement and its distribution to a recipient. Sender 122 wishes to refer/forward ad placement 120 to recipient 130. Sender 122 sends an SMS containing the unique ad ID and the recipients mobile contact information to the advertisement platform phone number or shortcode. Advertisement forwarder 124 then identifies and matches the mobile ad corresponding to the unique ad ID found in the SMS from sender 122 from the mobile ads stored in a database, shown as advertisement repository 126. The corresponding mobile ad is then sent to the mobile device of recipient 130 as an SMS or MMS message. The mobile ad provides contact information, either as a website or phone number, which allows the recipient to follow the advertisement. The contact information provided, either as a website or a phone number, directs the recipient back to the advertisement platform so that the instance of the recipient following the advertisement may be captured.

Advertisement tracker 128 identifies the merchant associated with the ad ID, by matching the ad ID sent to a merchant in advertisement repository 126, and directs the recipient to merchant 132. Methods for identifying the merchant associated with a mobile ad include website URL naming conventions which provide the ad ID and unique contact information phone number for each merchant and/or ad ID.

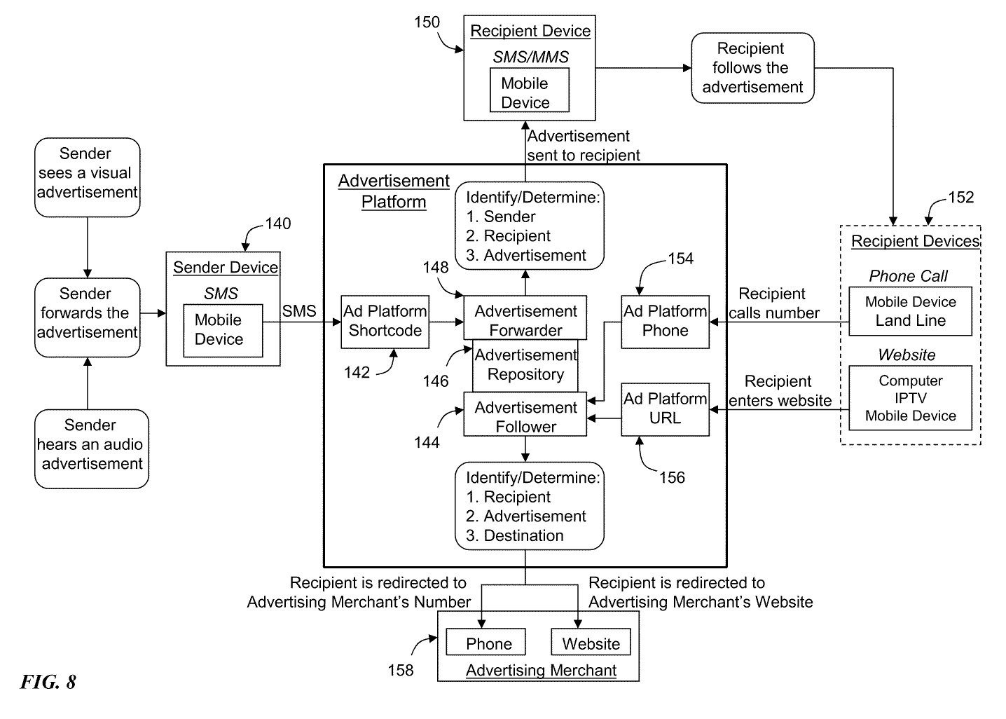

FIG. 8 is a graphic representation of an embodiment of a process flow displaying the devices used in accordance with the disclosed subject matter. A sender sees or hears an advertisement placement that they wish to forward to another. The sender then forwards the advertisement by using sender device 140, a mobile device, to send an SMS message comprising a unique ad ID communicated with the advertisement placement and the mobile device phone number for the recipient's mobile device to ad platform shortcode 142, an SMS gateway. From the SMS message, advertisement forwarder 148 identifies the sender's mobile device number, the recipient's mobile device phone number, and the mobile advertisement to be sent to the recipient stored in advertisement repository 146. The mobile advertisement is then sent to recipient device 150, a mobile device, as an SMS or MMS mobile advertisement. The recipient may then follow the advertisement by using the contact information provided along with the mobile advertisement. Recipient device 152 includes a mobile device and landline to use contact information provided as a phone number and a computer, IPTV, or mobile device to open a website provided as contact information. Ad platform phone 154 receives the phone call and ad platform URL 156 receives the website request from the recipient. Advertisement follower 144 then identifies the recipient, the advertisement the recipient received, and the destination to forward the recipient to (the proper advertising merchant) based on the ad ID and corresponding merchant information stored advertisement repository 146. The recipient is then directed to the phone number or website of advertising merchant 158.

In addition to providing a word of mouth advertising method for traditional media advertisements, the present method also may monetize the referral of the ad content. This may occur when the ad is forwarded from a sender to a receiver and when the receiver takes action on the ad.

The disclosed advertisement placement transformation and distribution methods provide advantages to traditional print media advertisers looking to move their media online. The disclosed subject matter provides a convergence of traditional print and online advertising by allowing print ads to be distributed via an “online” model. Ads that were initially viewed on traditional print may be distributed via mobile devices to receivers who never had exposure to the actual printed media. For example, an ad viewed in a phonebook, magazine, or at the point of a purchase can be sent via text to an interested contact. Thus the disclosed subject matter solves the problem of distribution of an ad outside of its traditional print media.

IPTV providers looking to maximize the value of their IP TV product in conjunction with their wireless and wire line products may also find the disclosed subject matter valuable. The disclosed subject matter uses the wireless network as a backbone and allow IPTV providers to offer businesses a suite of advertising solutions across multiple platforms (TV, wireless, and wire line).

Media buyers looking for new distribution outlets of current ad content will also find the disclosed subject matter beneficial. The disclosed subject matter puts the distribution of the ad into the hands of a sender who has intimate knowledge that the receiver will have interest in its content. This in turn delivers the most personalized form of on-line advertising to the end recipient.

Monetization methods of the ad forwarding aspect of the disclosed subject matter include: Standard Advertising Rates—the disclosed advertising platform provides the same functionality as TV and Radio advertising and therefore may be monetized in a similar fashion. That is, the more “eyes and ears” on an ad the greater the value of the distribution method. Pay-Per-Impression—The publisher earns a commission for every 1,000 impressions (page views/displays) of text, banner image or rich media ads. Once an ad is forwarded from a sender to a receiver through the advertisement platform, a negotiated Pay-Per-Impression rate may be collected for that ad.

The monetization methods of the receiver taking action on the ad aspect of the disclosed subject matter include: Pay-Per-Call—pay per call is a business model for ad listings in search engines and directories that allows publishers to charge local advertisers on a per-call basis for each lead (call) they generate (CPA). The advertising platform may collect when an ad is viewed by a receiver and the receiver places a call directly from the phone number provided in the ad to the merchant through the advertisement platform. Pay-Per-Click—The advertiser pays the publisher a commission every time a visitor clicks on the advertiser's ad. It is irrelevant (for the compensation) how often an ad is displayed because the commission is only due when the ad is clicked. The advertisement platform may collect when an ad is viewed by the receiver and they click on that ad and are subsequently routed through the advertisement platform.

Further, the disclosed subject matter provides innovative advertisement tracking capabilities. Specifically, the disclosed subject matter allows advertisers and media buyers to measure the effectiveness of the channels that are used to distribute the ad. The disclosed subject matter allows advertisers to answer the following questions: How do you measure offline advertising success when it comes to directing people to your online web site? The disclosed subject matter can track the source of the ad (i.e. magazine) according to the unique ad ID of the ad placement and determine if that ad resulted in a hit on the advertiser's web page. How do you measure the effectiveness of a TV or Radio ad? The disclosed subject matter may track the media source that distributed an ad, the time and place that the ad was broadcast, and link these metrics with an eventual call or web site visit by a potential customer to an advertiser. How do you measure and promote of word of mouth advertising? 67% of all consumer decisions are primarily influenced by word of mouth (McKinsey). However there is no way to measure or promote the fact that people are spreading the word about a particular product or service. The disclosed subject matter provides this level of detail which provides insight into how future advertising campaign's can take advantage of word of mouth recommendations.

In operation, the disclosed subject matter allows for traditional media advertisements, such as print content, to be delivered online and a way for consumers to become distributors of advertising content—by sending targeted print content to a receiver.

Additionally, the disclosed subject matter brings word of mouth advertising into the mobile age by allowing people to easily distribute advertising content that they are viewing to their friends and family members via a mobile device (such as a mobile phone). The disclosed subject matter utilizes the benefits of “word of mouth” advertising, mobile advertising being extremely targeted and both time and locality sensitive, and the reach of traditional media such as print, radio, and television. Anyone who is exposed to an advertisement, regardless of the source (i.e. TV, IPTV, radio, or print) can forward that ad content, via their mobile phone, to one of their contacts who may be interested in this information according to the disclosed subject matter.

In operation, the disclosed subject matter provides a method, system, and storage medium for easily distributing advertising content to other users via a mobile device. Allowing an advertisement to be forwarded, regardless of the source (e.g. TV, IPTV, Radio, Print, etc.) to another user via: texting an advertisement ID and a phone number to the system or texting a phone number to a shortcode which itself is the advertisement ID. The platform then matches the advertisement ID to the mobile video, audio, or print ad and messages that mobile ad to the receiver. The receiver of the mobile ad can then contact the merchant through the platform via a phone call (wire line or wireless) or via the Internet. The disclosed subject matter may track both the transmittal of the ad from the sender to the receiver as well as the contact between the receiver and the merchant.

What is claimed is:

1. A method for the transformation of an advertisement placement and the targeted distribution of a mobile advertisement, the method comprising:
storing a mobile advertisement in a database associated with an advertisement platform;
associating a unique ad ID identifying a corresponding advertisement placement with said mobile advertisement, said unique ad ID communicated to an advertisement sender with said corresponding advertisement placement;
parsing a message provided by said advertisement sender to identify said unique ad ID and mobile device contact information for an advertisement recipient in order to send said associated mobile advertisement to said advertisement recipient;
recording said advertisement placement information based on said unique ad ID received from said advertisement sender;
messaging said mobile advertisement to said advertisement recipient, said mobile advertisement comprising contact information wherein said contact information provides a network path for said advertisement recipient to contact said merchant routed through said advertisement platform; and
recording instances that said advertisement recipient is routed through said advertisement platform to said merchant.

2. The method of claim 1, wherein said advertisement placement is a print media advertisement placement.

3. The method of claim 1, wherein said advertisement placement is an audio media advertisement placement.

4. The method of claim 1, wherein said step of messaging said mobile advertisement to said advertisement recipient further comprises SMS messaging said mobile advertisement to said advertisement recipient.

5. The method of claim 1, wherein said step of messaging said mobile advertisement to said advertisement recipient further comprises MMS messaging said mobile advertisement to said advertisement recipient.

6. The method of claim 1, wherein said step of messaging said mobile advertisement to said advertisement recipient further comprises messaging said mobile advertisement and a personalized message provided by said advertisement sender to said advertisement recipient.

7. The method of claim 1, wherein said contact information is a phone number.

8. The method of claim 1, wherein said contact information is a website link.

9. The method of claim 1, wherein said unique ad ID is a shortcode.

10. The method of claim 1, further comprising the step of reporting to said merchant said recorded advertisement placement information and said recorded instances that said advertisement recipient is routed through said advertisement platform to said merchant.

11. A tangible computer-readable medium encoded with a computer-implemented program for the transformation of an advertisement placement and the targeted distribution of a mobile advertisement, the program comprising the steps of:
instructions for storing a mobile advertisement in a database associated with an advertisement platform;
instructions for associating a unique ad ID identifying a corresponding advertisement placement with said mobile advertisement, said unique ad ID communicated to an advertisement sender with said corresponding advertisement placement;
instructions for parsing a message provided by said advertisement sender to identify said unique ad ID and mobile device contact information for an advertisement recipient in order to send said associated mobile advertisement to said advertisement recipient;
instructions for recording said advertisement placement information based on said unique ad ID received from said advertisement sender;
instructions for messaging said mobile advertisement to said advertisement recipient, said mobile advertisement comprising contact information wherein said contact information provides a network path for said advertisement recipient to contact said merchant routed through said advertisement platform; and
instructions for recording instances that said advertisement recipient is routed through said advertisement platform to said merchant.

12. The tangible computer-readable medium of claim 10, wherein said advertisement placement is a print media advertisement placement.

13. The tangible computer-readable medium of claim 10, wherein said advertisement placement is an audio media advertisement placement.

14. The tangible computer-readable medium of claim 10, wherein said step of messaging said mobile advertisement to said advertisement recipient further comprises SMS messaging said mobile advertisement to said advertisement recipient.

15. The tangible computer-readable medium of claim 10, wherein said step of messaging said mobile advertisement to said advertisement recipient further comprises MMS messaging said mobile advertisement to said advertisement recipient.

16. The tangible computer-readable medium of claim 10, wherein said step of messaging said mobile advertisement to said advertisement recipient further comprises messaging said mobile advertisement and a personalized message provided by said advertisement sender to said advertisement recipient.

17. The tangible computer-readable medium of claim 10, wherein said contact information is a phone number.

18. The tangible computer-readable medium of claim 10, wherein said contact information is a website link.

19. The tangible computer-readable medium of claim 10, wherein said unique ad ID is a shortcode.

20. The tangible computer-readable medium of claim 10, wherein said tangible computer-readable medium encoded with a computer-implemented program further comprises instructions for reporting to said merchant said recorded advertisement placement information and said recorded instances that said advertisement recipient is routed through said advertisement platform to said merchant.
